(19) United States
(12) Patent Application Publication
(10) Pub. No.: US 2009/0135260 A1
(43) Pub. Date: May 28, 2009

(54) Method and System for Image Stabilization

(76) Inventors: Jarkko Rouvinen, Espoo (FI); Petteri Kauhanen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/085,816

(22) PCT Filed: Jan. 27, 2006
(86) PCT No.: PCT/IB2006/000154

§ 371 Date: Nov. 3, 2008

Related U.S. Application Data
(60) Provisional application No. 60/741,219, filed on Nov. 30, 2005.

(51) Int. Cl. H04N 5/228

(52) U.S. Cl. 348/208.11; 348/E05.031

(57) ABSTRACT

An optical image stabilizer for use in a camera to compensate for an unwanted movement of camera, wherein two bending actuators are used to shift a lens element or the image sensor in different directions in a plane so as to shift a projected image on the image sensor in response to the unwanted camera movement. The plane is substantially perpendicular to the optical axis of camera, and longitudinal axis of each bending actuator is substantially parallel to the optical axis. The actuator can be fixedly mounted on one end so that the other end is allowed to bend. The actuator can be fixedly mounted on both ends so that the middle section is allowed to bend. Alternatively, the middle section is fixedly mounted and both ends can be used for shifting an imaging component.

### FIELD OF THE INVENTION

The present invention relates generally to a camera and, more particularly, to the stabilization of an image during the exposure time of the camera.

### BACKGROUND OF THE INVENTION

The problem of image stabilization dates back to the beginning of photography, and the problem is related to the fact that an image sensor needs a sufficient exposure time to form a reasonably good image. Any motion of the camera during the exposure time causes a shift of the image projected on the image sensor, resulting in a degradation of the formed image. The motion related degradation is called motion blur. Using one or both hands to hold a camera while taking picture, it is almost impossible to avoid an unwanted camera motion during a reasonably long exposure time. Motion blur is particularly easy to occur when the camera is set at a high zoom ratio when even a small motion could significantly degrades the quality of the acquired image.

Optical image stabilization generally involves laterally shifting the image projected on the image sensor in compensation for the camera motion. Shifting of the image can be achieved by one of the following four general techniques:

Lens shift—this optical image stabilization method involves moving one or more lens elements of the optical system in a direction substantially perpendicular to the optical axis of the system;

Image sensor shift—this optical image stabilization method involves moving the image sensor in a direction substantially perpendicular to the optical axis of the optical system;

Liquid prism—this method involves changing a layer of liquid sealed between two parallel plates into a wedge in order to change the optical axis of the system by refraction; and

Camera module tilt—this method keeps all the components in the optical system unchanged while tilting the entire module so as to shift the optical axis in relation to a scene.

A schematic representation of a camera is shown in FIG. 1. As shown, the image plane is parallel to the XY plane, and the placement of the lens and the image sensor is such that the optical axis is substantially parallel to the Z-axis. In any one of the above-mentioned image stabilization techniques, an actuator mechanism is required to effect the change in the optical axis or the shift of the image sensor. Actuator mechanisms are generally complex, which means that they are expensive and large in size.

The present invention provides a new method and device for shifting one or more lens elements or the image sensor in an XY-plane, wherein the arrangement of the actuators is simple and cost-effective.

### SUMMARY OF THE INVENTION

The present invention uses an optical image stabilizer to compensate for an unwanted movement of an imaging system, such as a camera. Two bending actuators are used to shift a lens element or the image sensor in different directions in a plane so as to shift a projected image on the image sensor based on the movement of the imaging system. The plane is substantially perpendicular to the optical axis of the imaging system, and longitudinal axis of each bending actuator is substantially parallel to the optical axis. In one embodiment of the present invention, one end of each bending actuator is fixedly disposed on the image system and the other end is used to shift the lens element or the image sensor. In another embodiment of the present invention, both ends of each bending actuator are fixed, while the middle section is allowed to move for shifting the lens element or the image sensor.

Thus the present invention provides a method and system for optical image stabilization for use in an imaging system having a plurality of imaging components arranged in relationship to an optical axis, the imaging components comprising an image sensor and at least a lens element for projecting an image on the image sensor, wherein the projected image can be shifted relative to the image sensor in a direction substantially perpendicular to the optical axis. The imaging system comprises:

a first bending actuator operatively connected to at least one of the imaging components for moving the imaging component in a first direction, the first bending actuator having a length defining a first actuator axis;

a second bending actuator operatively connecting said at least one imaging component for moving the imaging component in a second direction, the second bending actuator having a length defining a second actuator axis, wherein the optical axis and each of the first and second actuator axes form an angle smaller than 45 degrees.

a driving system, in response to the movement of the imaging system, for causing at least part of the first actuator to move in a direction different from the first actuator axis so as to shift said at least one imaging component in a plane substantially perpendicular to the optical axis, and for causing at least part of the second actuator to move in a direction different from the second actuator axis so as to shift said at least one imaging component in a plane substantially perpendicular to the optical axis. The imaging component can be a lens component or the image sensor.

Each of the bending actuator can be mounted on the imaging system in a number of ways. The actuator can be fixedly mounted on one of its ends so as to allow the other end to bend. The actuator can be fixedly mounted on both ends so as to allow the middle section to move. Alternatively, the actuator can be fixedly mounted on a middle section so that one or both ends can be used to move an imaging component.

The present invention will become apparent upon reading the description taken in conjunction with FIGS. 3 to 15.

### BRIEF DESCRIPTION OF THE DRAWINGS

FIG. 1 shows a schematic representation of an imaging system.

FIG. 2 shows an on-axis actuator disposed parallel to the Y-axis.

FIG. 3 shows a bending or off-axis actuator.

FIG. 4a shows a bending actuator for shifting a carrier along the Y-axis, according to the present invention.

FIG. 4b shows a bending actuator for shifting a carrier along the X-axis, according to the present invention.

FIG. 5 shows a carrier having two bending actuators for shifting the image sensor in an imaging system.

FIG. 6 shows the details of the image sensor carrier.

FIGS. 7A to 7C show the carrier being shifted to the left, center and right position along the X-axis.

FIG. 8 shows a slight variation in the placement of a bending actuator in reference to the optical axis of the imaging system.

FIG. 9 shows another variation in the placement of a bending actuator in reference to the optical axis of imaging system.

FIG. 10A shows a lens carrier having two bending actuators for shifting the lens in an imaging system.

FIG. 10B shows a first sheet metal frame connected to an actuator for movement along the Y-axis.

FIG. 10C shows a second sheet metal frame connected to another actuator for movement along the X-axis.

FIG. 11 shows a different lens carrier.

FIG. 12 shows a different bending actuator.

FIG. 13 shows a lens carrier having two bending actuators, according to a different embodiment of the present invention.

FIG. 14 shows a typical driving system for driving a bending actuator.

FIG. 15 shows a typical image stabilizer system.

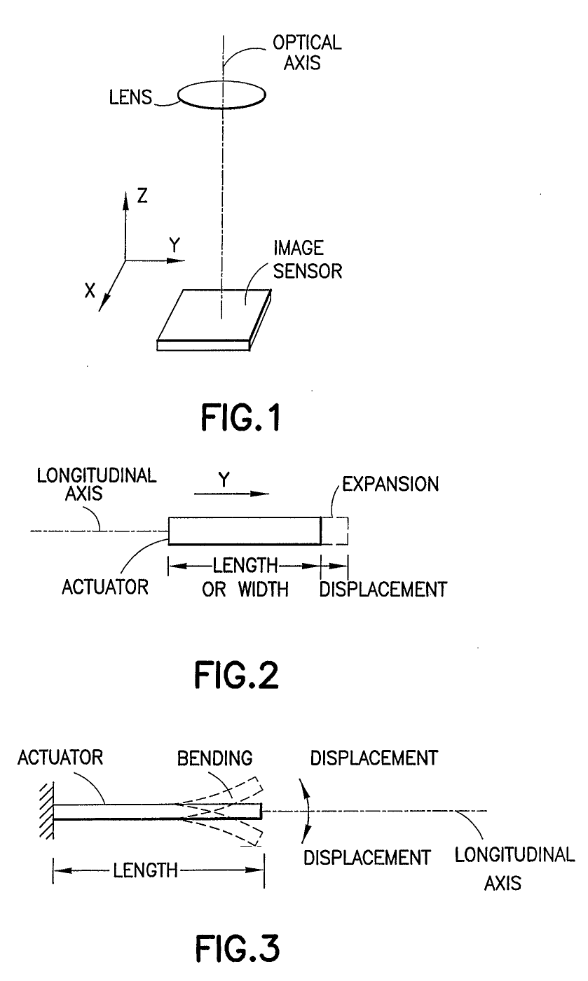

### DETAILED DESCRIPTION OF THE INVENTION

In an imaging system having an image sensor and a lens to project an image on the image sensor, the present invention uses one or more bending actuators to shift the image projected on the image sensor for image stabilization purposes. The actuators can be used to shift the lens or the image sensor or both in one or more directions substantially parallel to the image plane, which is substantially the same as the plane of the image sensor. The actuators are mechanically engaged with a carrier carrying the imaging component to be shifted.

When an on-axis actuator is activated, it contracts or expands in a direction that shortens or lengthens the thickness or the length of the actuator. For example, if the actuator is a long piece of piezoelectric material having a longitudinal axis along its length, then the displacement of the actuator when activated is also along the longitudinal axis, as shown in FIG. 2. In a bending actuator, as shown in FIG. 3, the displacement of the actuator is not along its length or longitudinal axis. Instead, the displacement is off-axis and approximately equal to the length times the bending angle.

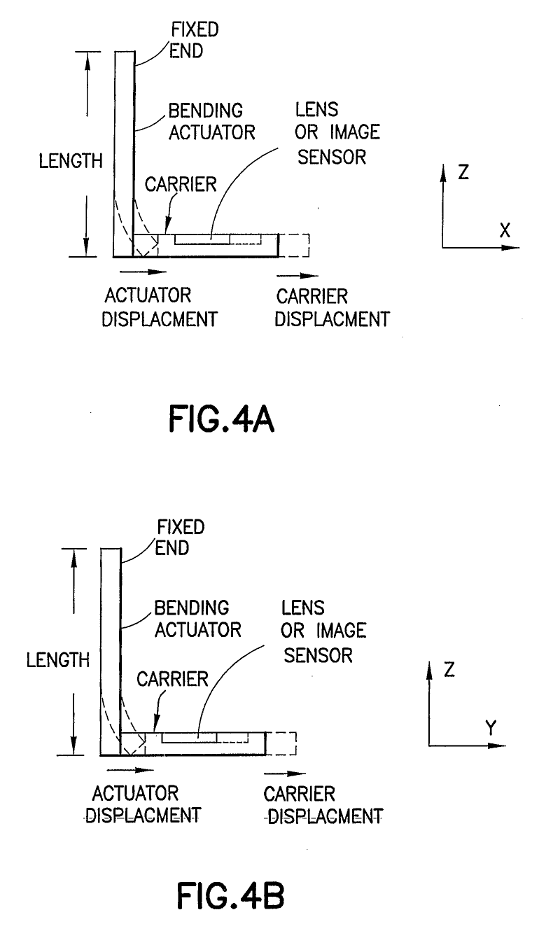

When it is used to move a lens element or the image sensor in a camera, a bending actuator can be disposed such that the longitudinal axis of the actuator is parallel to the optical axis of the camera so as to move the camera component in a direction perpendicular to the optical axis. FIGS. 4a and 4b show the principle of using a bending actuator to move a carrier in the X-direction and in the Y-direction, with the optical axis being parallel to the Z-axis.

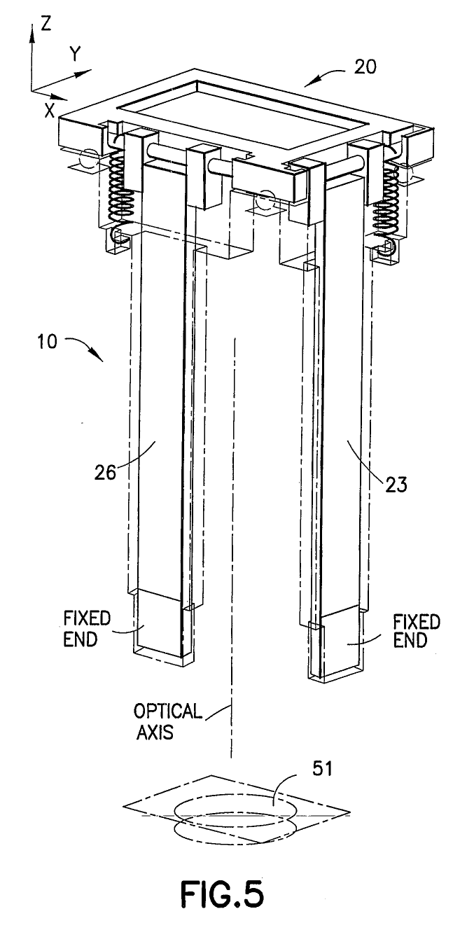

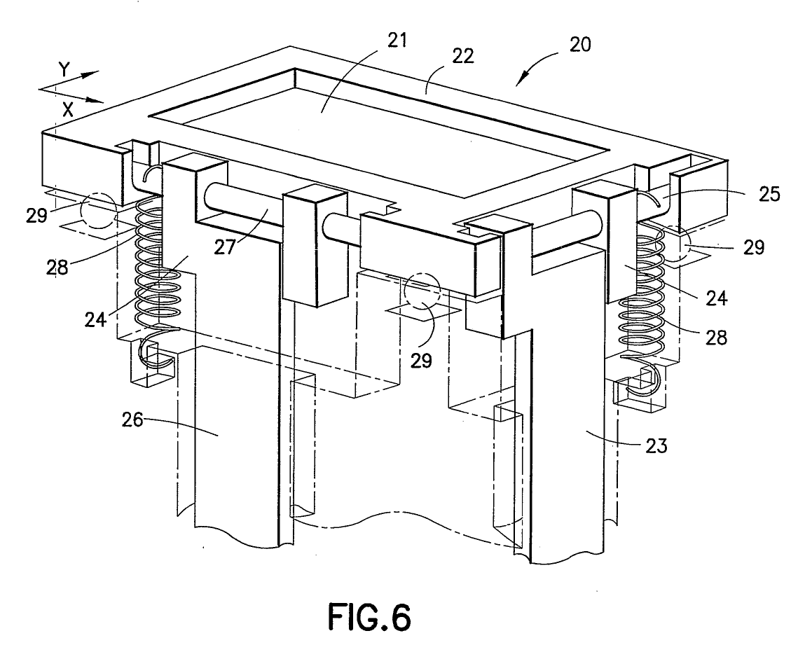

According to one of the embodiment of the present invention, the image sensor is fixedly mounted on the carrier to be moved by a pair of bending actuators, as shown in FIGS. 5 and 6. As shown, the imaging system 10, according to the present invention, comprises a lens 51 for projecting an image on an image sensor 40 (not shown) along the optical axis of the imaging system. The image sensor 40 is mounted on a sensor carrier 20. The carrier can be moved in the X direction by a bending actuator 23 and in the Y direction by another bending actuator 26. The detail of the carrier 20 is shown in FIG. 6. As shown, the carrier 20 comprises an image sensor circuit board 21 fixedly mounted on a frame 22. The image sensor 40 is mounted on the reverse side of the circuit board 21. A guide pin 27 for the X-direction movement is mounted on one side of the frame 22, and a guide pin 25 for the Y-direction movement is mounted on another side of the frame. One end of the actuator 23 (for X-direction shift) is moveably mounted on the guide pin 25 via a pair of brackets 24 and the other end of the actuator 23 is fixed from its base in the imaging system. Likewise, one end of the actuator 26 (for Y-direction shift) is moveably mounted on the guide pin 27 via another pair of brackets 24, and the other end of the actuator 26 is fixed from its base. As such, when the actuator 23 is caused to bend in the X-direction, the sensor frame 22 can be moved along the X-direction by sliding on the guide pin 27. Likewise, when the actuator 26 is caused to bend in the Y-direction, the sensor frame 22 can be moved along the Y-direction by sliding on the guide pin 25. By using ball bearings 29 as supporting elements between the carrier 20 and the stationary part of the imaging system 10, it is possible to use a single carrier to shift the projected image on the image sensor for image stabilization purposes. Furthermore, the sensor frame is pulled together with the stationary part of the imaging system 10 by two or three coil springs 28. The springs 28 provide suitable normal force against the bearing 29 so that there is minimal friction and zero mechanical clearance between the contacting elements.

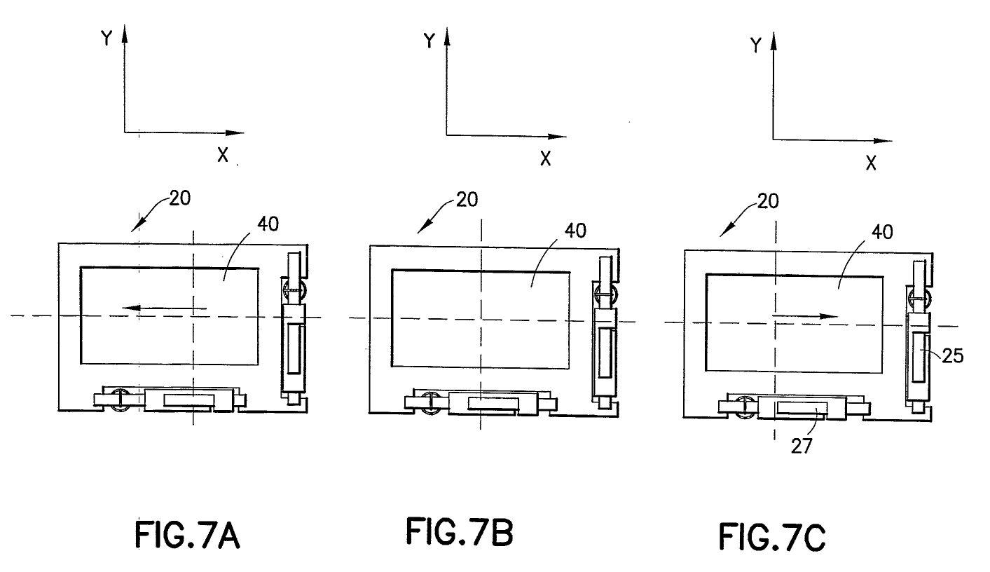

The shifting of the image sensor 40 in the X-direction is depicted in FIGS. 7A to 7C. FIG. 7A shows the image sensor 40 being shifted to the left. FIG. 7B shows the image sensor 40 being positioned in the center, and FIG. 7C shows the image sensor 40 being shifted to the right.

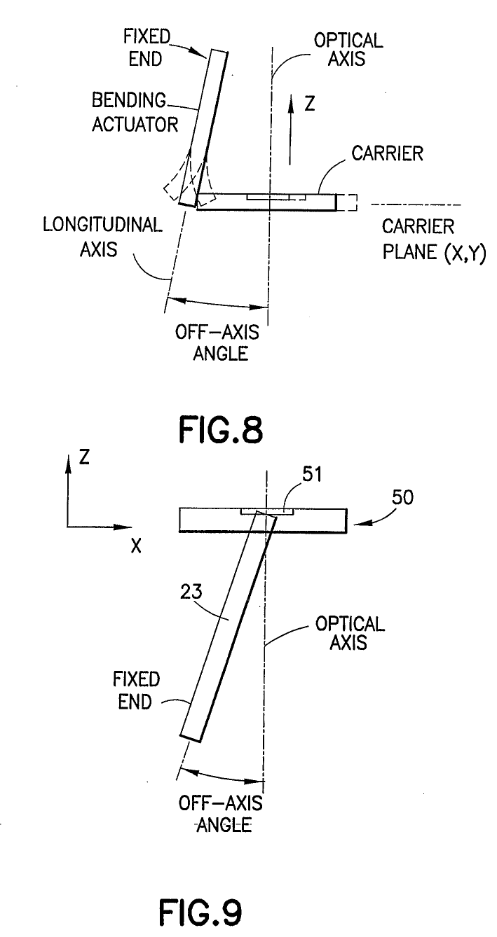

The placement of bending actuators in the imaging system can be carried out differently. The bending actuators, according to the present invention, are not necessarily parallel to the optical axis. For example, the longitudinal axis of the bending actuator can form a non-zero angle with the optical axis of the imaging system, as shown in FIG. 8. Nevertheless, the fixed end of the bending actuator along its longitudinal axis is spaced from the carrier plane. In practice, the “off-axis” angle between the bending actuator and the optical axis should not be greater than 45 degrees, for example.

It should be noted that, in FIG. 8, the bending actuator is depicted as being placed in a plane that is not perpendicular to the XY plane. In FIG. 5, the bending actuator 23 is depicted as being placed substantially in the YZ plane and as being parallel to the optical axis (Z-axis). It is also possible to place the bending actuator differently. As shown in FIG. 9, the bending actuator 23 is placed in the YZ plane but it is not parallel to the optical axis (Z-axis). The off-axis angle between the actuator 23 and the Z-axis, in practice, should not be greater than 45 degrees.

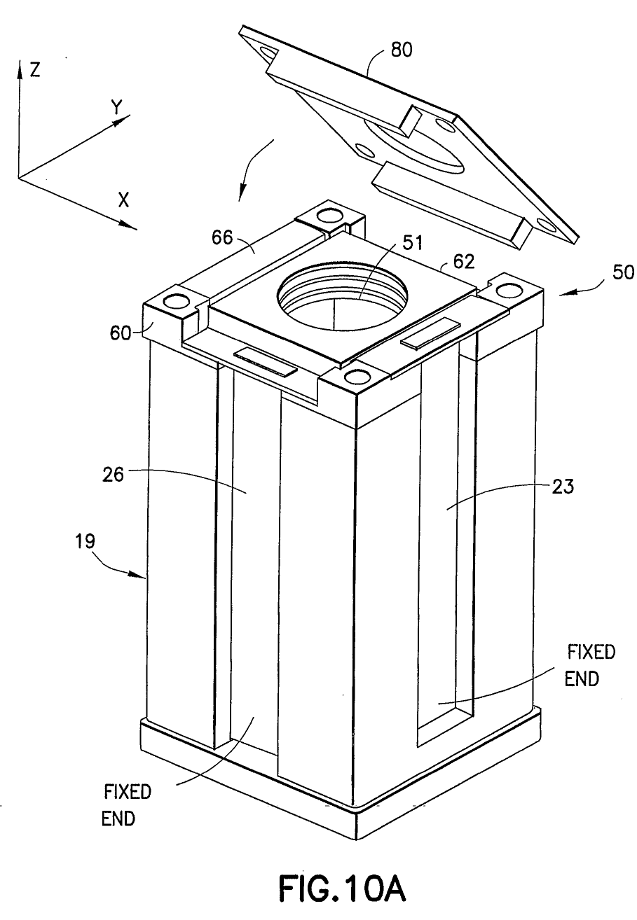

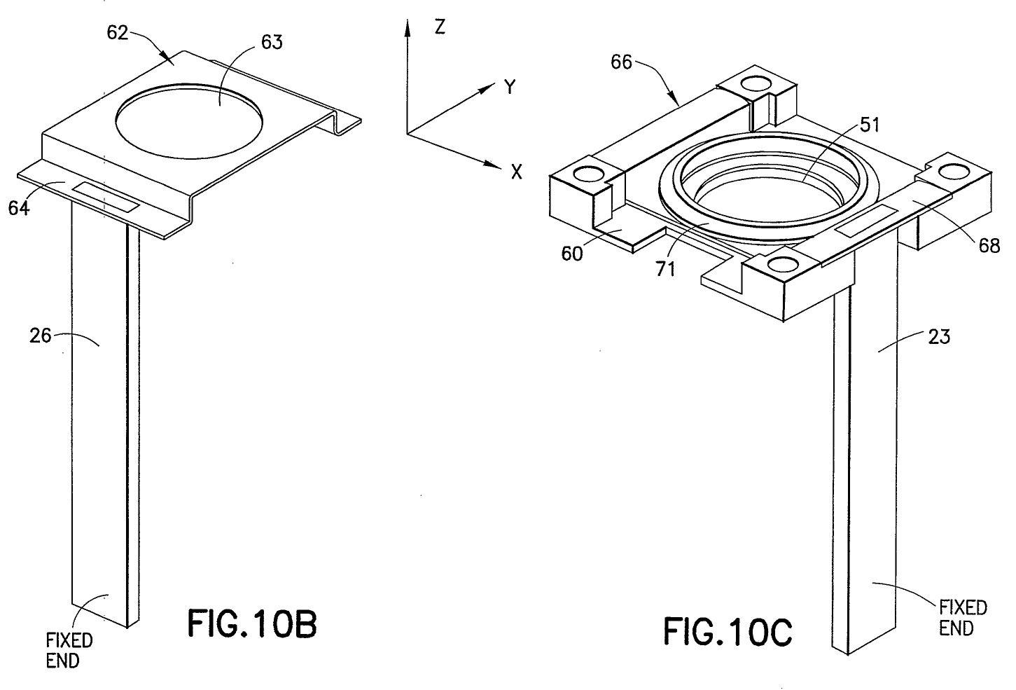

The bending actuators, according to another embodiment of the present invention, are used to move the lens element 51, instead of moving the image sensor, as shown in FIGS. 10A-10C. As shown in FIG. 10A, the imaging system 10 has a stationary body 19 for fixedly mounting one end of the actuator 23 and one end of the actuator 26. A lens carrier 50 is movably positioned on top of the stationary body 19. The lens carrier 50 has a supporting plate 60 which is dimensioned to accommodate two sheet metal frames 62, 66 for shifting the lens element 51. A cover 80 is placed on top of the supporting plate 60 to complete the imaging system. As shown in FIGS. 10B and 10C, the lens element 51 is mounted on a lens frame 71. The frame 62 has an aperture 63 dimensioned to fit the top part of the lens frame 71. The frame 62 also has a slot 64 to accommodate the bending end of the actuator 26. The frame 66 has an aperture (not shown) dimensioned to fit the bottom part of the lens frame 71. The frame 66 also has a slot 68 to accommodate the bending end of the actuator 23.

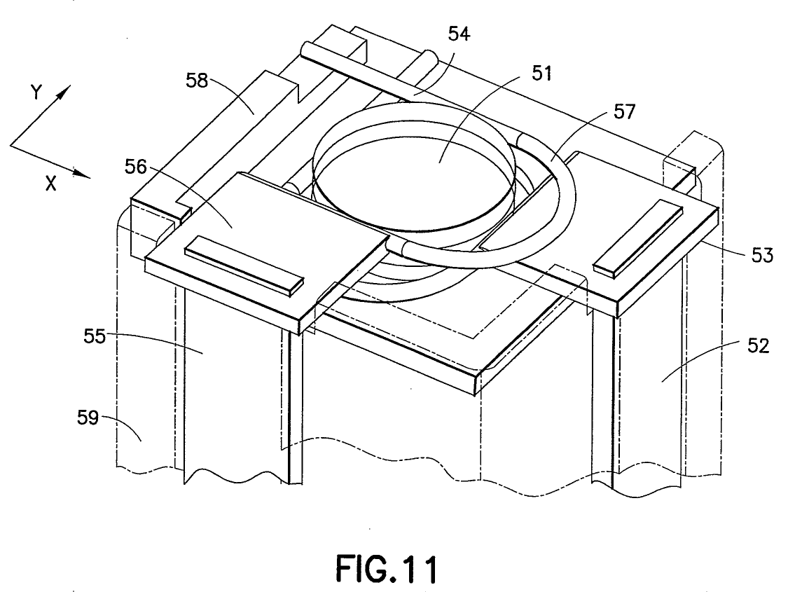

A different lens carrier design is shown in FIG. 11. As shown in FIG. 11, the carrier 50 comprises a correction framework 58 for mounting an actuator 52 for the X-direction movement via a bracket 53, and for mounting another actuator 55 for the Y-direction movement via a bracket 56. A U-shaped hook 57 is fixedly attached to the bracket 56 and another U-shaped hook 54 is fixedly attached to the bracket 53 to move the lens element 51. The position of the lens element 51 is determined substantially by the parallel sections of each of the hooks 54, 57. For example, when the actuator 55 moves in the Y-direction in response to activation, the lens element is guided by the U-shaped hook 57 to move along the Y-direction.

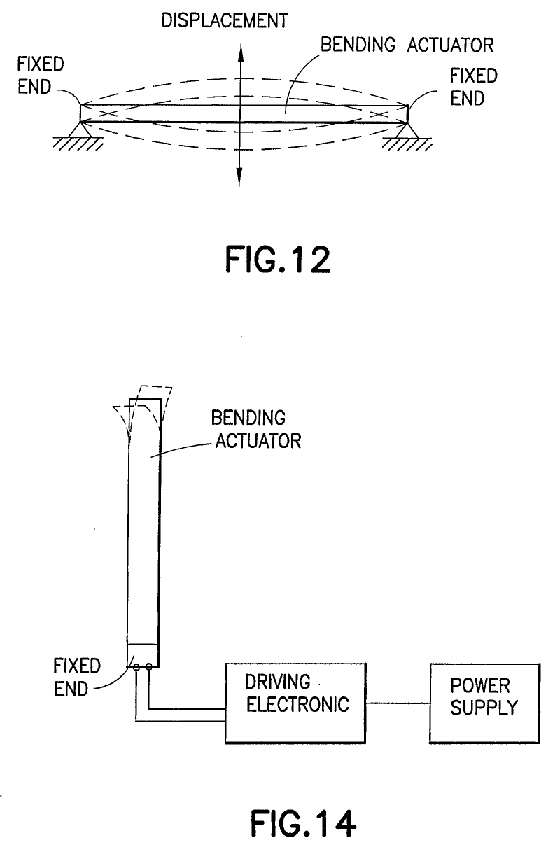

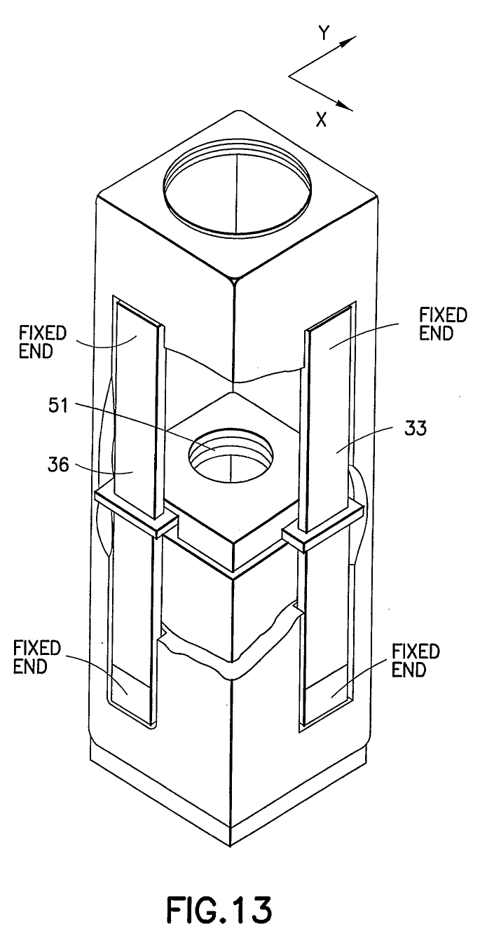

Furthermore, the bending actuators can be used in a different setting. As shown in FIGS. 12 and 13, both ends of the actuator are fixedly mounted to the stationary part of the imaging system. When the actuator is activated, the middle section of the actuator undergoes a bending motion to move a carrier. For example, both ends of an actuator 33 are fixedly mounted to one side of the stationary part 59 of the imaging system, and both ends of another actuator 36 are fixedly mounted to another side of the stationary part 59. Brackets are used to attach a lens carrier 50 at the middle section of each actuator. When the actuator 33 is activated, it is able to move to lens carrier in the X-direction. Likewise, when the actuator 36 is activated, it is able to move the lens carrier in the Y-direction for image stabilization purposes. In a different embodiment, one or more sections between the ends are fixedly mounted so as to allow both ends to bend and to use one or both of the ends for moving the carrier. It should be noted the same carrier can also be used to shift the image sensor 40.

It should be noted that the bending actuator, according to the present invention, can be a piezoelectric monomorph actuator, a piezoelectric bimorph actuator, a piezoelectric multi-layer actuator, an ion conductive polymer actuator or the like. Furthermore, it is known in the art that an actuator needs a driving system for activating the actuator. FIG. 14 is a typical driving system. As shown, the actuator is operatively connected to a driving electronic module, which is connected to a camera movement sensor/signal processor so that the actuator moves the imaging component in response to the camera movement. The driving system is not part of the present invention. Moreover, the lens of the imaging system may comprise two or more lens elements and the actuators may be used to move one or more lens elements.

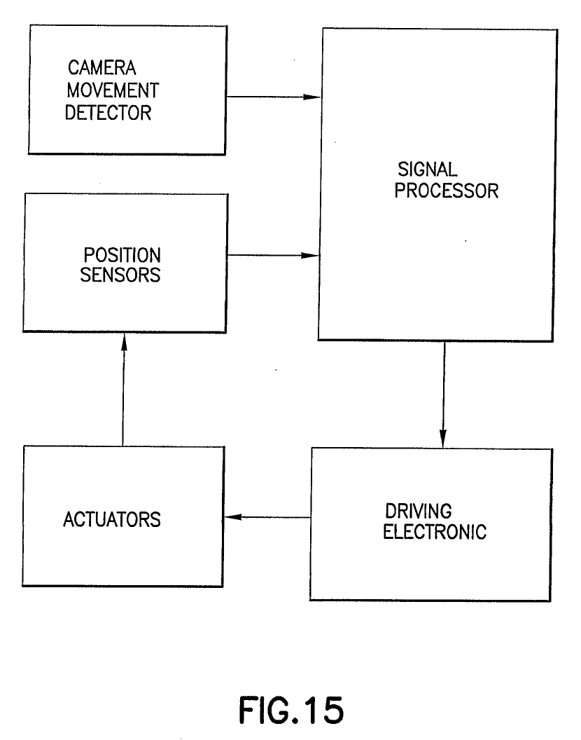

Furthermore, when one or more of the imaging components are shifted for image stabilization purposes, other components are also needed. For example, the image stabilizer for the imaging system also has a movement detector to determine the movement to be compensated for, at least one position sensors to determine the current position of the imaging components, a signal processor to compute the shifting amount in different directions for compensating for the camera movement based on the positions of the components and the camera movement, and an actuator control to activate the actuators in order to shift the image components by a desired amount. A block diagram illustrating such an image stabilizer is shown in FIG. 15. The movement detector may include a gyroscope or accelerometer or other known movement detection device, for example.

It should be understood for a person skilled in the art that the carrier 20 as depicted in FIG. 6 and the carrier 50 as depicted in FIGS. 10A-10B and 11 are for illustration purposes only. The present invention in which two bending actuators are used to shift an imaging component, such as a lens element and an image sensor, can also be achieved with a different carrier design or arrangement. Furthermore, the carrier 20 and 50 can also be used to shift other imaging components for optical image stabilization purposes. For example, the carrier 20 or 50 can be used to shift two optical wedges or thin prisms separately in the X-direction and Y-direction.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. An apparatus, comprising
an apparatus body;
a plurality of imaging components arranged in the apparatus body in relationship to an optical axis, the imaging components comprising an image sensor disposed in an image plane and at least a lens element for projecting an image on the image sensor, wherein the projected image is shiftable relative to the image plane in a direction substantially perpendicular to the optical axis in response to a movement of the apparatus;
a bending actuator operatively connected to at least one of the imaging components, the bending actuator having a length defining an actuator axis; and
a driving module, in response to the movement of the apparatus, for causing at least part of the actuator to move in a direction different from the actuator axis so as to shift said at least one imaging component in a plane substantially perpendicular to the optical axis.

2. The apparatus of claim 1, wherein the shift of said at least one imaging component is in a first direction in the plane, said apparatus further comprising:
a further bending actuator operatively connecting said at least one imaging component, the further bending actuator having a length defining a further actuator axis, wherein the further bending actuator is operatively connected to the driving system module so that the further actuator can be caused to move in a further direction different from the further actuator axis so as to shift said at least one imaging component in the plane in a second direction different from the first direction.

3. The apparatus of claim 1, wherein said one imaging component comprises the lens element.

4. The apparatus of claim 1, wherein said one imaging component comprises the image sensor.

5. The apparatus of claim 1, wherein said actuator has a first end and an opposing second end defining the length and wherein the first end is fixedly mounted on the apparatus body relative to the optical axis and the second end is operatively connected to said at least one imaging component so that the second end of the actuator is moveable in the direction different from the actuator axis.

6. The apparatus of claim 5, wherein the second end of the actuator is spaced from the plane.

7. The apparatus of claim 1, wherein the actuator axis is substantially parallel to the optical axis.

8. The apparatus of claim 2, wherein the further actuator axis is substantially parallel to the optical axis.

9. The apparatus of claim 1, wherein said actuator has a first end, an opposing second end and a middle section between the first and second ends, and both the first and second end are fixedly mounted on the apparatus body relative to the optical axis and the middle section is operatively connected to said at least one imaging component so that the middle section of the actuator is moveable in the direction different from the actuator axis.

10. The apparatus of claim 9, wherein said at least one imaging component comprises the lens.

11. The apparatus of claim 1, wherein said actuator has a first end, an opposing second end and a middle section between the first and second ends, and the middle section is fixedly mounted on the apparatus body relative to the optical axis and both the first and second end are operatively connected to said at least one imaging component so that both the first and second end of the actuator are moveable in the direction different from the actuator axis.

12. The apparatus of claim 2, further comprising:
a movement sensing module for detecting the movement of the apparatus.

13. The apparatus of claim 12, wherein the movement sensing module comprises one or more gyroscope sensors.

14. The apparatus of claim 12, wherein the movement sensing module comprises one or more accelerometers.

15. The apparatus of claim 12, further comprising:
at least one position sensing module for determining the current position of the imaging component to be shifted by the bending actuator.

16. The apparatus of claim 15, further comprising:
a processor, operatively connected to the movement sensing module and the position sensing module, for determining a shifting amount of the projected image in order to compensate for the movement of the apparatus, said processor further connected to the driving module to cause the actuator and the further actuator to move.

17. The apparatus of claim 1, wherein the actuator axis and the optical axis form an angle smaller than 45 degrees.

18. A method for use in an imaging apparatus, comprising:
operatively connecting at least one of a plurality of imaging components in the imaging apparatus to a bending actuator having a length defining an actuator axis, wherein the imaging components are arranged in relationship to an optical axis, the imaging components comprising at least an image sensor and a lens element for projecting an image on the image sensor, and wherein the projected image is shiftable in an image plane in a direction substantially perpendicular to the optical axis, and
causing at least part of the actuator to move in a direction different from the actuator axis so as to shift said at least one imaging component in a plane substantially perpendicular to the optical axis.

19. The method of claim 18, wherein the shift of said at least one imaging component is in a first direction in the plane, said method further comprising:
operatively connecting said at least one imaging component to a further bending actuator having a length defining a further actuator axis;
causing at least part of the further actuator to move in a further direction different from the further actuator axis so as to shift said at least one imaging component in the plane in a second direction different from the first direction.

20. The method of claim 18, wherein said one imaging component comprises the lens element.

21. The method of claim 18, wherein said one imaging component comprises the image sensor.

22. The method of claim 18, wherein the imaging apparatus comprises an apparatus body, and wherein said actuator has a first end and an opposing second end defining the length, said method further comprising:
fixedly mounting the first end on the apparatus body relative to the optical axis and operatively connecting the second end to said at least one imaging component so that the second end of the actuator is moveable in the direction different from the actuator axis.

23. The method of claim 18, wherein the imaging apparatus comprises an apparatus body, and wherein said actuator has a first end, an opposing second end and a middle section between the first and second ends, said method further comprising:
fixedly mounting both the first and second end on the apparatus body relative to the optical axis and operatively connecting the middle section to said at least one imaging component so that the middle section of the actuator is moveable in the direction different from the actuator axis.

24. The method of claim 18, wherein the imaging apparatus comprises an apparatus body, and wherein said actuator has a first end, an opposing second end and a middle section between the first and second ends, said method further comprising:
fixedly mounting the middle section on the apparatus body relative to the optical axis and operatively connecting the first and second ends to said at least one imaging component so that both the first and the second ends of the actuator are moveable in the direction different from the actuator axis.

25. An image stabilizer module for an imaging apparatus, said image stabilizer module comprising:
a first bending actuator operatively connected to at least one of a plurality of imaging components in the imaging apparatus, the imaging components comprising an image sensor and at least a lens element for projecting an image on the image sensor, wherein the projected image is shiftable relative to the image sensor in a direction substantially perpendicular to an optical axis, wherein the first bending actuator has a length defining a first actuator axis, and wherein at least part of the first actuator is dimensioned to move in a direction different from the first actuator axis so as to shift said at least one imaging component in a first direction in the plane based on the movement of the imaging apparatus, and
a second bending actuator operatively connected to said at least one imaging component, the second bending actuator having a length defining a second actuator axis, wherein at least part of the second actuator is dimensioned to move in a direction different from the second actuator axis so as to shift said at least one imaging component in a second direction in the plane also based on the movement of the imaging apparatus.

26. The image stabilizer module of claim 25, wherein said one imaging component comprises the lens element.

27. The image stabilizer module of claim 25, wherein said one imaging component comprises the image sensor.

28. The image stabilizer module of claim 25, wherein the imaging apparatus comprises an apparatus body and wherein said first actuator has a first end and an opposing second end defining the length of said first actuator, wherein the first end is fixedly mounted on the apparatus body relative to the optical axis and the second end is operatively connected to said at least one imaging component so that the second end of the first actuator is moveable in the direction different from the first actuator axis, and
said second actuator has a first end and an opposing second end defining the length of said second actuator, wherein the first end is fixedly mounted on the apparatus body relative to the optical axis and the second end is operatively connected to said at least one imaging component so that the second end of the second actuator is moveable in the direction different from the second actuator axis.

29. The image stabilizer module of claim 25, wherein the first actuator axis is substantially parallel to the optical axis and the second actuator axis is substantially parallel to the optical axis.

30. The image stabilizer module of claim 25, wherein the imaging apparatus comprises an apparatus body, and wherein said first actuator has a first end, an opposing second end and a middle section between the first and second ends, wherein both the first and second end are fixedly mounted on the apparatus body relative to the optical axis and the middle section is operatively connected to said at least one imaging component so that the middle section of the first actuator is moveable in the direction different from the first actuator axis, and
said second actuator has a first end, an opposing second end and a middle section between the first and second ends, wherein both the first and second end are fixedly mounted on the apparatus body relative to the optical axis and the middle section is operatively connected to said at least one imaging component so that the middle section of the second actuator is moveable in the direction different from the second actuator axis.

31. The image stabilizer module of claim 25, wherein the imaging apparatus comprises an apparatus body, and wherein said first actuator has a first end, an opposing second end and a middle section between the first and second ends, wherein the middle section is fixedly mounted on the apparatus body relative to the optical axis and both the first and second end are operatively connected to said at least one imaging component so that both the first and second end of the first actuator are moveable in the direction different from the first actuator axis, and
said second actuator has a first end, an opposing second end and a middle section between the first and second ends, wherein the middle section is fixedly mounted on the apparatus body relative to the optical axis and both the first and second end are operatively connected to said at least one imaging component so that both the first and second end of the second actuator are moveable in the direction different from the second actuator axis.
